(19) United States
(12) Patent Application Publication
(10) Pub. No.: US 2016/0006801 A1
(43) Pub. Date: Jan. 7, 2016

(54) DATA SHARING SYSTEM

(71) Applicant: NEC CORPORATION, Minato-ku, Tokyo (JP)

(72) Inventors: Hirofumi UEDA, Tokyo (JP); Norihito FUJITA, Tokyo (JP)

(73) Assignee: NEC Corporation, Minato-ku, Tokyo (JP)

(21) Appl. No.: 14/769,517

(22) PCT Filed: Dec. 4, 2013
(86) PCT No.: PCT/JP2013/007111

§ 371 Date: Aug. 21, 2015

(30) Foreign Application Priority Data
Feb. 22, 2013 (JP) 2013-032834

(51) Int. Cl. H04L 29/08; H04W 8/24

(52) U.S. Cl. CPC H04L 67/1074; H04W 8/24

(57) ABSTRACT

Provided is a data sharing system in which data are shared between a plurality of communication terminals capable of wirelessly transmitting and receiving a communication message to and from each other. Each communication terminal determines whether or not the own communication terminal is a specified terminal. Each communication terminal, in case of it is determined that the own communication terminal is a specified terminal, transmits a holding list that lists information about data that the own communication terminal holds, to another communication terminal through use of a communication message. Each communication terminal, when receiving a holding list from another communication terminal, transmits and receives communication messages to and from the other communication terminal that is a source of the holding list that does not match the holding list of the own communication terminal so as to share data with each other.

### TECHNICAL FIELD

The present invention relates to a data sharing system, a data sharing method, a communication terminal, and a program wherein data are shared between a plurality of communication terminals capable of wirelessly communicating with one another.

### BACKGROUND ART

As a type of method wherein data are shared between a plurality of communication terminals, there is a method in which data are shared in a distributed manner by individual communication terminals without using a central management apparatus such as a server.

For example, exchange and synchronization of information held in each communication terminal by an epidemic method while communication terminals move close to one another have been proposed as a first related technology related to the present invention (refer to, for example, NPL 1). In an epidemic method, when a communication terminal in a network detects another communication terminal, the communication terminal and the other communication terminal exchange a holding list (also referred to as “summary vector”) that lists information about data (content) held by each terminal, so that the communication terminal acquires the content of the holding list held in another communication terminal. The communication terminal checks for data that the own terminal does not hold, based on the received holding list, and attempts to acquire the data. For example, as illustrated in FIG. 15, a terminal T1 and a terminal T2 that have approached each other exchange holding lists with each other, and the terminal T2 checks for difference data by comparing the holding list of the own terminal and the holding list of the terminal T1 to determine whether there are any data that the own terminal does not hold. In the example illustrated in FIG. 15, the terminal T2 does not hold data B, therefore transmits an acquisition request for the data B to the terminal T1, and acquires the data B. All terminals within the network match information held in each terminal by repeating the operation.

Further, in order to solve a problem that frequent transmission of holding lists in information sharing by the epidemic method mentioned above leads to heavy bandwidth load, suppression of transmission of duplicating holding lists has been proposed as a second related technology related to the present invention (refer to, for example, PTL 1). More specifically, in the second related technology, a plurality of communication terminals are wirelessly connected to and communicating with one another without using an access point, so that data are shared between the plurality of communication terminals. Each communication terminal in the second related technology includes an internal deduction unit, a duplication determination unit, and an information exchange unit. The internal deduction unit deduces data that are presently held by another communication terminal by using a reception history of a holding list received from the other communication terminal. The duplication determination unit determines whether or not the data presently held by another communication terminal which has been deduced by the internal deduction unit match the data held by the own terminal. In case of the duplication determination unit determines that the data do not match, the information exchange unit transmits a holding list that contains the data held by the own terminal.

### CITATION LIST

### Patent Literature

[PTL 1] WO2011/071045

### Non Patent Literature

[NPL 1]A. Vandat, D. Becker, “Epidemic Routing for Partially-Connected Ad Hoc Networks,” Tech. Report CS-200006, Duke University, April 2000

### SUMMARY OF INVENTION

### Technical Problem

In the aforementioned first related technology, before data are transmitted and received between communication terminals, the communication terminals exchange the holding lists and each communication terminal acquires data that the own terminal does not hold from other communication terminals. Therefore, there is no unnecessary operation that data already held by another communication terminal or data not needed by the own communication terminal are transmitted or received between communication terminals. However, there is a problem that frequent transmission of holding lists causes heavier bandwidth load on a wireless link and impedes other communications. The second related technology is a technology that solves such a problem. However, since the second related technology is based on suppressing transmission of duplicating holding lists, it is difficult to suppress transmission of holding lists in a situation where there is no duplication between holding lists held by a plurality of communication terminals.

It is an object of the present invention to provide a data sharing system that solves the above-mentioned problem, in other words, the problem that it is difficult to suppress increase in bandwidth load on a wireless link caused by frequent transmission of holding lists.

### Solution to Problem

A data sharing system according to a first aspect of the present invention is a data sharing system in which data are shared between a plurality of communication terminals capable of wirelessly transmitting and receiving a communication message to and from one another, wherein each of the communication terminals includes: a communication unit that transmits and receives the communication message to and from another of the communication terminals; a data storage unit that stores one or more pieces of data; a specified terminal determination unit that determines whether or not the own communication terminal is a specified terminal; a holding list transmission unit that transmits, in case of the own communication terminal is the specified terminal, a holding list that lists information about the data stored in the data storage unit to another of the communication terminals through use of the communication message; and a data exchange unit that receives the holding list from another of the communication terminals, and transmits and receives the communication message to and from the other communication terminals that is a source of the holding list that does not match the holding list of the own communication terminal so as to share data with each other.

A data sharing method according to a second aspect of the present invention is a data sharing method in which data are shared between a plurality of communication terminals capable of wirelessly transmitting and receiving a communication message to and from one another, wherein: each of the communication terminals determines whether or not the own communication terminal is a specified terminal; the communication terminal determined to be the specified terminal transmits a holding list that lists information about data held by the own communication terminal to another of the communication terminals through use of the communication message; and the communication terminal receiving the holding list from another of the communication terminals transmits and receives the communication message to and from the other communication terminals that is a source of the holding list that does not match the holding list of the own communication terminal so as to share data with each other.

A communication terminal according to a third aspect of the present invention includes: a communication unit that transmits and receives a communication message to and from another communication terminal; a data storage unit that stores one or more pieces of data; a specified terminal determination unit that determines whether or not the own communication terminal is a specified terminal; a holding list transmission unit that transmits, in case of the own communication terminal is the specified terminal, a holding list that lists information about the data stored in the data storage unit to another of the communication terminals through use of the communication message; and a data exchange unit that receives the holding list from another of the communication terminals, and transmits and receives the communication message to and from the other communication terminal that is a source of the holding list that does not match the holding list of the own communication terminal so as to share data with each other.

A data sharing method according to a fourth aspect of the present invention is a data sharing method executed by a communication terminal including a communication unit that transmits and receives a communication message to and from another communication terminal and a data storage unit that stores one or more pieces of data, the method including the steps of determining whether or not a communication terminal itself is a specified terminal, transmitting, in case of the own communication terminal is the specified terminal, a holding list that lists information about the data stored in the data storage unit to another of the communication terminals through use of the communication message, receiving the holding list from another of the communication terminals, and transmitting and receiving the communication message to and from the other communication terminal that is a source of the holding list that does not match the holding list of the own communication terminal so as to share data with each other.

A program according to a fifth aspect of the present invention causes a computer to function as: a communication unit that transmits and receives a communication message to and from another communication terminal; a data storage unit that stores one or more pieces of data; a specified terminal determination unit that determines whether or not the own communication terminal is a specified terminal; a holding list transmission unit that transmits, in case of the own communication terminal is the specified terminal, a holding list that lists information about the data stored in the data storage unit to another of the communication terminals through use of the communication message; and a data exchange unit that receives the holding list from another of the communication terminals, and transmits and receives the communication message to and from the other communication terminal that is a source of the holding list that does not match the holding list of the own communication terminal so as to share data with each other.

### Advantageous Effects of Invention

The foregoing structure of the present invention enables suppression of increase in bandwidth load on a wireless link caused by frequent transmission of holding lists.

### BRIEF DESCRIPTION OF DRAWINGS

FIG. 1 is an overall configuration diagram of a data sharing system according to a first exemplary embodiment of the present invention.

FIG. 2 is a block diagram illustrating a configuration of a communication terminal included in the data sharing system according to the first exemplary embodiment of the present invention.

FIG. 3 is a flowchart illustrating a data sharing procedure in the data sharing system according to the first exemplary embodiment of the present invention.

FIG. 4 is a diagram illustrating an example of a data sharing scene in the data sharing system according to the first exemplary embodiment of the present invention.

FIG. 5 is a diagram illustrating another example of a data sharing scene in the data sharing system according to the first exemplary embodiment of the present invention.

FIG. 6 is an overall configuration diagram of a data sharing system according to a second exemplary embodiment of the present invention.

FIG. 7 is a block diagram illustrating a configuration of a communication terminal included in the data sharing system according to the second exemplary embodiment of the present invention.

FIG. 8 is a flowchart illustrating a data sharing procedure in the data sharing system according to the second exemplary embodiment of the present invention.

FIG. 9 is a block diagram of a data sharing system according to a third exemplary embodiment of the present invention.

FIG. 10 is a block diagram of a data sharing system according to a fourth exemplary embodiment of the present invention.

FIG. 11 is a block diagram of a data sharing system according to a fifth exemplary embodiment of the present invention.

FIG. 12 is an explanatory diagram of a data exchange method adopted in the data sharing system according to the fifth exemplary embodiment of the present invention.

FIG. 13 is an explanatory diagram of a data exchange operation in the data sharing system according to the fifth exemplary embodiment of the present invention.

FIG. 14 is a block diagram of a communication terminal included in a data sharing system according to a sixth exemplary embodiment of the present invention.

FIG. 15 is a diagram illustrating an example of a procedure of data sharing by an epidemic method.

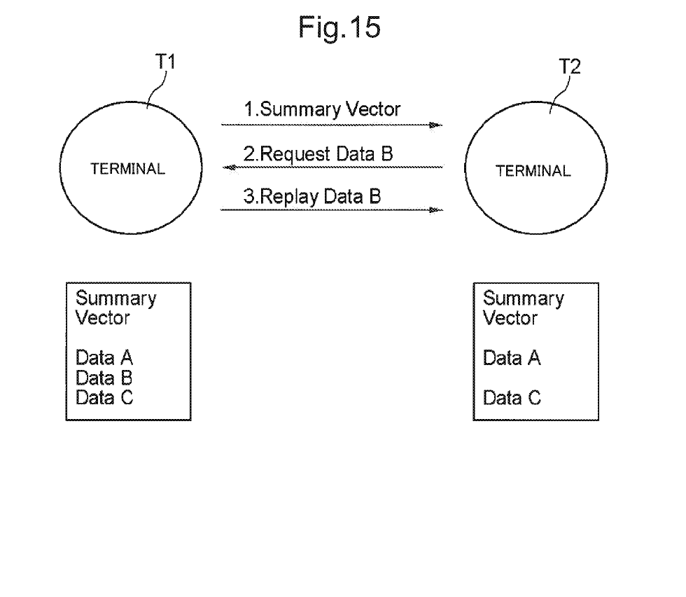

### DESCRIPTION OF EMBODIMENTS

Next, exemplary embodiments of the present invention will be described in detail with reference to the drawings.

### First Exemplary Embodiment

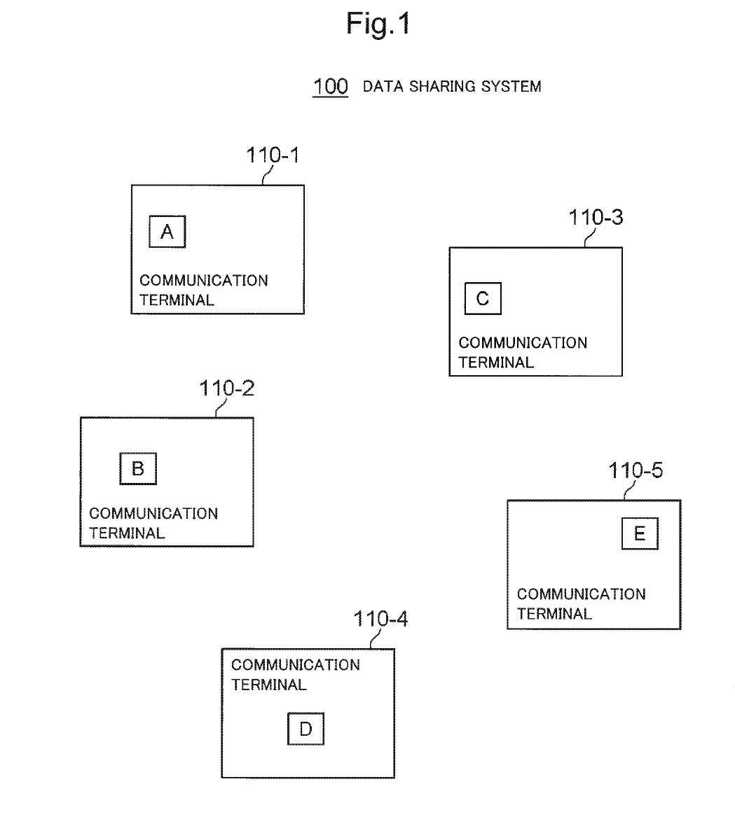

Referring to FIG. 1, a data sharing system 100 according to a first exemplary embodiment of the present invention includes a plurality of communication terminals 110 that are capable of wirelessly transmitting and receiving communication messages to and from one another. As for the individual communication terminals 110, all of the terminals may be mobile communication terminals, or some of the terminals may be mobile communication terminals and the others may be fixed terminals. Although in FIG. 1 only five communication terminals are drawn, the number of communication terminals may be four or less or may also be six or more.

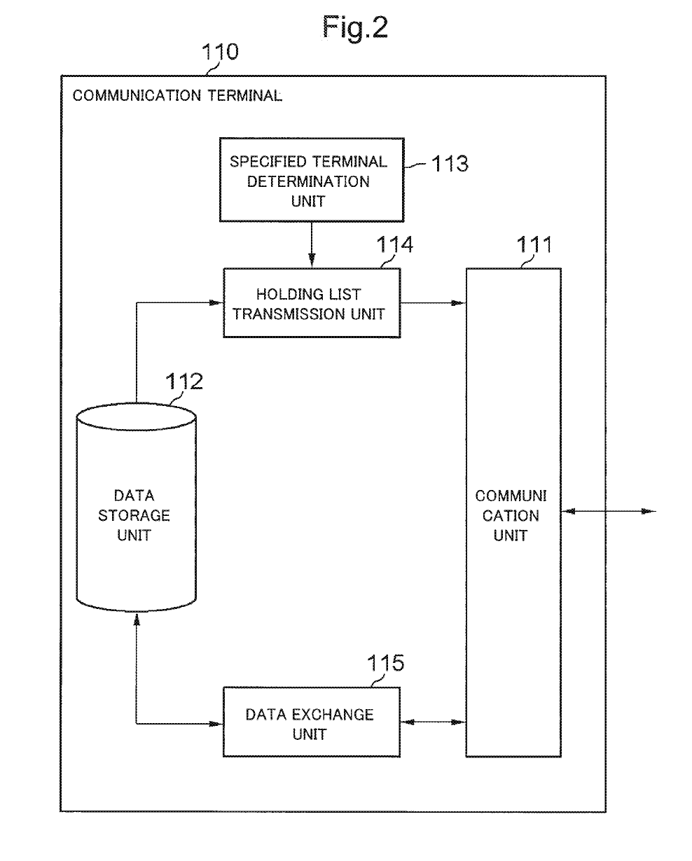

FIG. 2 illustrates a configuration example of a communication terminal 110. Referring to FIG. 2, the communication terminal 110 includes a communication unit 111, a data storage unit 112, a specified terminal determination unit 113, a holding list transmission unit 114, and a data exchange unit 115.

The communication unit 111 has a function of wirelessly transmitting and receiving communication messages to and from other communication terminals 110. Choice of communication method to be used by the communication unit 111 is arbitrary.

The data storage unit 112 stores one or more pieces of data. Choice of individual data is arbitrary. For example, the data may include any of text data, image data, and voice data, as well as mixture thereof. Further, the data may be what are called content.

The specified terminal determination unit 113 has a function of determining whether or not the own communication terminal 110 is a specified terminal. The specified terminal herein means a terminal authorized to transmit a holding list. Choice of function determining whether or not the own communication terminal 110 is a specified terminal may be arbitrary as long as the function is based on a method other than a method in which the own communication terminal 110 is always determined as a specified terminal.

The holding list transmission unit 114 has a function of transmitting a holding list that lists information about data stored in the data storage unit 112, to other communication terminals 110 through the communication unit 111. The information about data listed in the holding list is arbitrary as long as the information is capable of identifying the data, and, for example, the information may be a summary vector or may also be a data identifier. The holding list transmission unit 114 transmits a holding list only in case of the specified terminal determination unit 113 determines the own communication terminal 110 as a specified terminal, and does not transmit the holding list in case of the own communication terminal 110 is not a specified terminal. Transmission of a holding list is carried out, for example, in every fixed cycle.

The data exchange unit 115 has a function of receiving a holding list from another communication terminal 110 through the communication unit 111 and transmitting and receiving communication messages through the communication unit 111 with another communication terminal 110 having a holding list that does not match the holding list of the own communication terminal 110 so as to share data with each other. In case of providing data that another communication terminal 110 does not hold from the own communication terminal 110 to the other communication terminal 110 for data sharing, the data exchange unit 115 reads out the corresponding data from the data storage unit 112 and transmits the data to the other communication terminal 110 through use of a communication message. Further, in case of receiving data that the own communication terminal 110 does not hold through use of a communication message from the other communication terminal 110 for data sharing, the data exchange unit 115 stores the received data into the data storage unit 112.

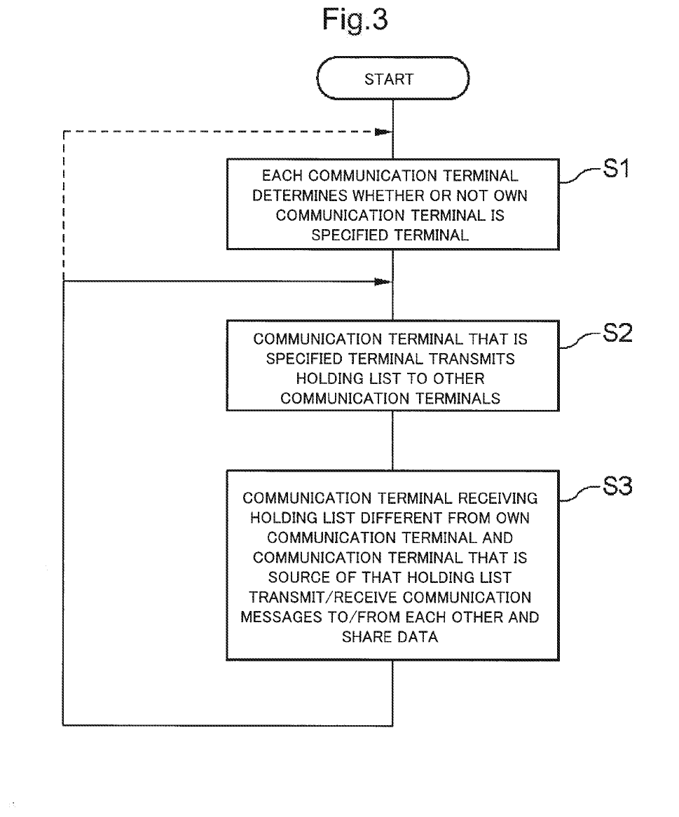

Next, an operation in which a plurality of communication terminals 110 in the data sharing system according to the present exemplary embodiment mutually share data held by individual terminals will be described with reference to a flowchart in FIG. 3.

In case of data sharing is performed in the data sharing system 100, first, each communication terminal 110 determines whether or not the own communication terminal is a specified terminal by using the specified terminal determination unit 113 (Step S1).

Next, a communication terminal 110 that determines that the own terminal is a specified terminal transmits, by using the holding list transmission unit 114, a holding list that lists data held by the own communication terminal to another communication terminal 110 through the communication unit 111 (Step S2).

Next, a communication terminal 110 that receives a holding list from another communication terminal 110 transmits and receives communication messages to and from another communication terminal 110 having a holding list that does not match the holding list of the own communication terminal through the communication unit 111 by using the data exchange unit 115, so as to share data with each other (Step S3).

Thereafter, the processing of the aforementioned steps S2 to S3 is repeatedly performed. Alternatively, the processing of the aforementioned steps S1 to S3 may be repeatedly performed.

By the operation described above, data can be shared between a plurality of communication terminals 110.

Hereinafter, the operation of the present exemplary embodiment will be more specifically described.

It is assumed that the plurality of communication terminals 110 illustrated in FIG. 1 hold respectively different data as indicated in FIG. 1. Specifically, it is assumed that the communication terminal 110-1 holds data A, the communication terminal 110-2 holds data B, the communication terminal 110-3 holds data C, the communication terminal 110-4 holds data D, and the communication terminal 110-5 holds data E as data to be shared with other communication terminals.

It is also assumed that in the processing of the step S1 in FIG. 3, the communication terminal 110-1 of the plurality of communication terminals 110 is determined as a specified terminal and the remaining communication terminals 110-2 to 110-5 are not determined as specified terminals. In this situation, in the step S2 in FIG. 3, only the communication terminal 110-1 transmits a holding list indicating that the communication terminal 110-1 holds the data A, to the other communication terminals 110.

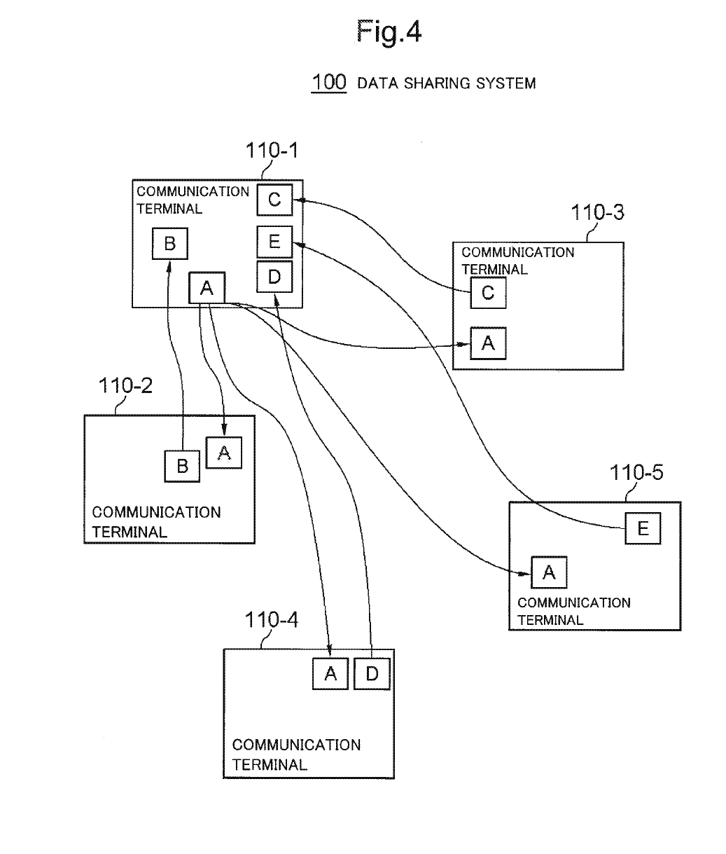

The communication terminals 110-2 to 110-5 compare the holding list received from the communication terminal 110-1 with the holding lists of the own communication terminals, and respectively detect differences. Consequently, in the step S3 in FIG. 3, each of the communication terminals 110-2 to 110-5 transmits and receives communication messages to and from the communication terminal 110-1 so as to share data with each other. As a result, as illustrated in FIG. 4, the communication terminal 110-1 acquires the data B to E not present in the own communication terminal from the communication terminals 110-2 to 110-5. Further, the communication terminals 110-2 to 110-5 acquire the data A not present in the own communication terminals from the communication terminal 110-1.

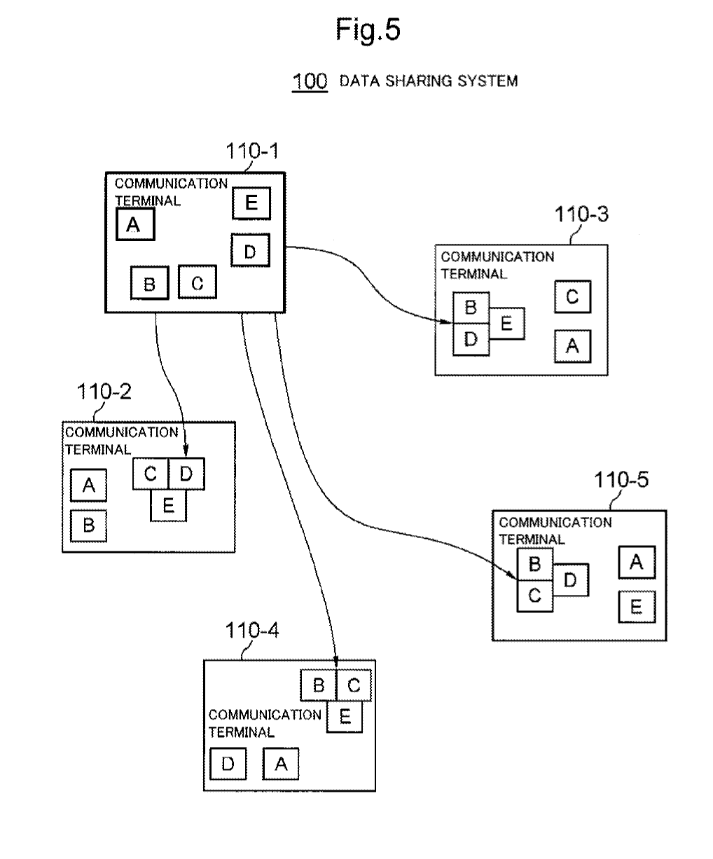

Thereafter, when the processing in the step S2 in FIG. 3 is performed again, only the communication terminal 110-1 transmits a holding list indicating that the data A to E are held, to the other communication terminals 110. The communication terminals 110-2 to 110-5 compare the holding list received from the communication terminal 110-1 with the holding lists of the own communication terminals, and respectively detect differences. Consequently, each of the communication terminals 110-2 to 110-5, again in the step S3, transmits and receives communication messages to and from the communication terminal 110-1 to perform data sharing again. As a result, as illustrated in FIG. 5, the communication terminal 110-2 acquires the data C, D, and E not present in the own communication terminal from the communication terminal 110-1. The communication terminal 110-3 acquires the data B, D, and E not present in the own communication terminal from the communication terminal 110-1. The communication terminal 110-4 acquires the data B, C, and D not present in the own communication terminal from the communication terminal 110-1. The communication terminal 110-5 acquires the data B, C, and E not present in the own communication terminal from the communication terminal 110-1. Consequently, all the communication terminals 110 can mutually share the data A to E.

Thus, according to the present exemplary embodiment, increase in bandwidth load on a wireless link caused by frequent transmission of holding lists can be suppressed. A reason for this is that only a communication terminal determined that the own communication terminal is a specified terminal transmits a holding list to other communication terminals.

Further, according to the present exemplary embodiment, a communication terminal (unspecified terminal) receiving a holding list from another communication terminal (specified terminal) transmits and receives communication messages to and from the communication terminal (specified terminal) that is a source of the holding list that does not match the holding list of the own communication terminal, so that the communication terminals share data with each other. Therefore, data can be shared by all communication terminals that are present within a range where communication with a communication terminal that transmits a holding list (specified terminal) is available.

### Second Exemplary Embodiment

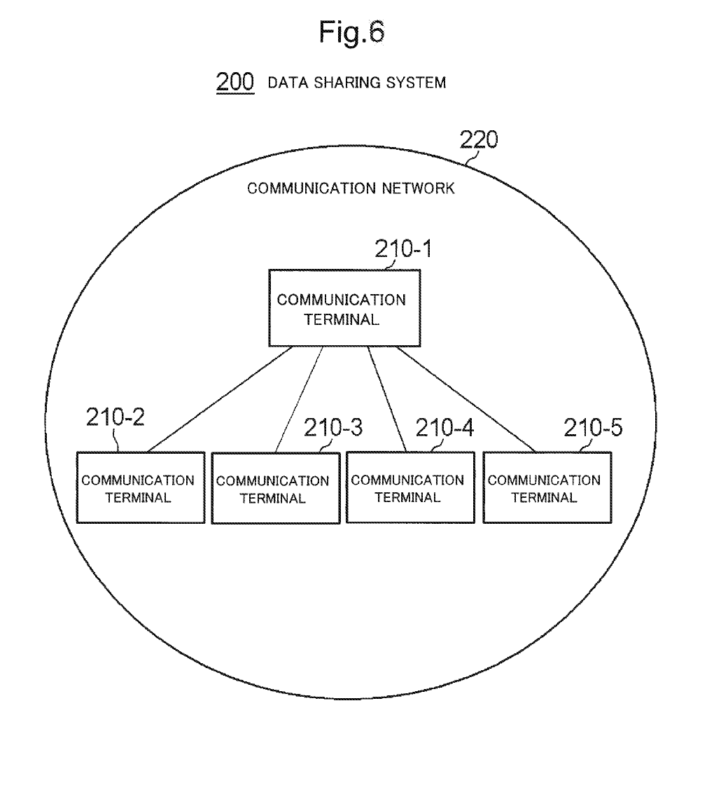

Referring to FIG. 6, in a data sharing system 200 according to a second exemplary embodiment of the present invention, a plurality of communication terminals 210 capable of wirelessly transmitting and receiving communication messages to and from one another form one communication network 220. As for the individual communication terminals 210, all of the terminals may be mobile communication terminals, or some of the terminals may be mobile communication terminals and the others may be fixed terminals. Although in FIG. 6 only five communication terminals are drawn, the number of communication terminals may be four or less, or may also be six or more.

The communication network 220 has a hierarchized network topology. In the present exemplary embodiment, the network topology is made up of two hierarchies, a parent and a child. Of the plurality of communication terminals 210 connected to the communication network 220, only one communication terminal 210 functions as a parent and all the remaining communication terminals 220 function as children. In the communication network 220, transmission and reception of communication messages between child communication terminals 210 are performed via the parent communication terminal 210. In other words, the parent communication terminal 210 functions as an access point.

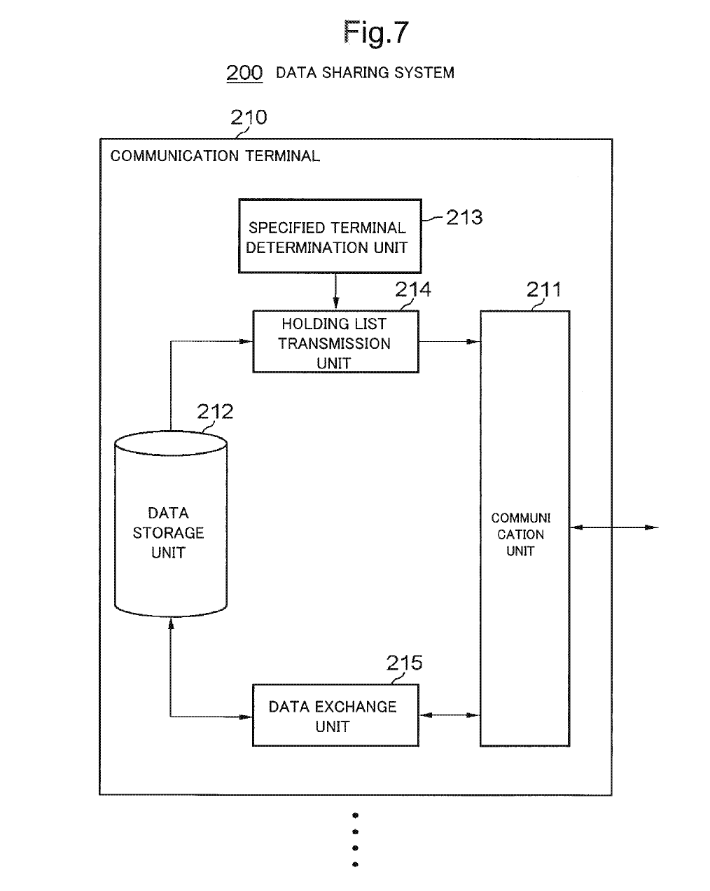

FIG. 7 illustrates a configuration example of a communication terminal 210. Referring to FIG. 7, the communication terminal 210 includes a communication unit 211, a data storage unit 212, a specified terminal determination unit 213, a holding list transmission unit 214, and a data exchange unit 215.

The data storage unit 212, the holding list transmission unit 214, and the data exchange unit 215 have the same functions as the data storage unit 112, the holding list transmission unit 114, and the data exchange unit 115, respectively, of the communication terminal 110 according to the first exemplary embodiment illustrated in FIG. 2.

The specified terminal determination unit 213 has a function of determining whether or not the own communication terminal 210 is the parent communication terminal in the communication network 220. The specified terminal determination unit 213 negotiates with other communication terminals 210 by transmitting and receiving communication messages to and from the other communication terminals 210 through the communication unit 211 as to whether or not the own communication terminal 210 is the parent communication terminal.

In response to a result of the aforementioned negotiation, the communication unit 211 controls whether a relay function of the own communication terminal 210 is enabled or disabled. Specifically, when the own communication terminal 210 is determined as the parent communication terminal, the communication unit 211 enables the relay function in order to make the own communication terminal 210 function as an access point.

The aforementioned communication network 220 and the aforementioned negotiation may be, for example, a network and a negotiation that conform to a Wi-Fi direct specification. In a network conforming to the Wi-Fi direct specification, only one communication terminal among a plurality of communication terminals participating in the network is selected as a group owner and functions as an access point. Further, the aforementioned group owner is selected through a negotiation among the plurality of communication terminals participating in the network. However, a network and a negotiation in the present invention are not limited to a network and a negotiation that conform to a Wi-Fi direct specification, but may also be another similar network and negotiation.

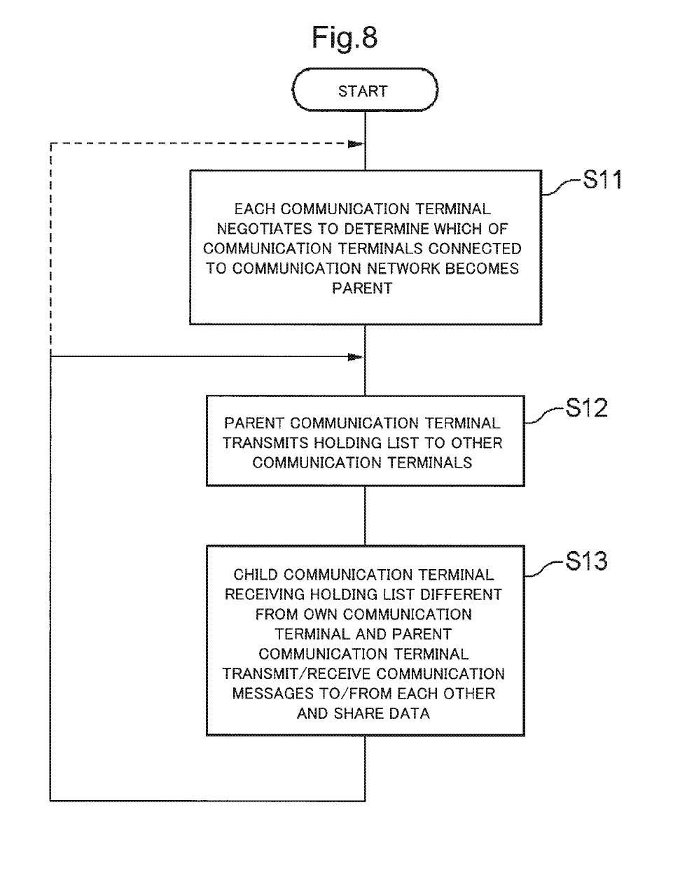

Next, in the data sharing system of the present exemplary embodiment, an operation in which a plurality of communication terminals 210 share data held in each of the communication terminals with one another will be described with reference to a flowchart in FIG. 8.

In case of data sharing is performed in the data sharing system 200, first, each communication terminal 210 negotiates, using the specified terminal determination unit 213, with other communication terminals 210 as to which of the communication terminals connected to the communication network 220 is determined as a parent (Step S11).

Next, the communication terminal 210 determined as a parent through the aforementioned negotiation transmits, using the holding list transmission unit 214, a holding list that lists information about data held by the own communication terminal, to child communication terminals 210 through the communication unit 211 (Step S12).

Next, a child communication terminal 210 receiving a holding list from the parent communication terminal 210 transmits and receives, using the data exchange unit 215, communication messages through the communication unit 211 to and from the parent communication terminal 210 holding a holding list that does not match the holding list of the own communication terminal, so as to share data with each other (Step S13).

Thereafter, the processing of the steps S12 to S13 is repeated. Alternatively, in a case that the parent communication terminal 210 departs from the communication network 220, or the like, the processing of the steps S11 to S13 may be repeated.

Based on the foregoing operation, a plurality of communication terminals 210 can share data.

Thus, according to the present exemplary embodiment, increase in bandwidth load on a wireless link caused by frequent transmission of holding lists can be suppressed. A reason for this is that, of all the communication terminals 210 connected to the communication network 220, the only one communication terminal that becomes a parent transmits a holding list to the child communication terminals.

Further, according to the present exemplary embodiment, each child communication terminal receiving a holding list from the parent communication terminal transmits and receives communication messages to and from the parent communication terminal having a holding list that does not match the holding list of the own communication terminal, so as to share data with each other. Therefore, data sharing among all the communication terminals connected to the communication network 220 is possible.

Furthermore, according to the present exemplary embodiment, since shared data exchange between the parent and child communication terminals is performed as a one-hop communication, increase in bandwidth load of wireless resource can be suppressed compared with a case that shared data exchange between child communication terminals is performed as a two-hop communication.

### Third Exemplary Embodiment

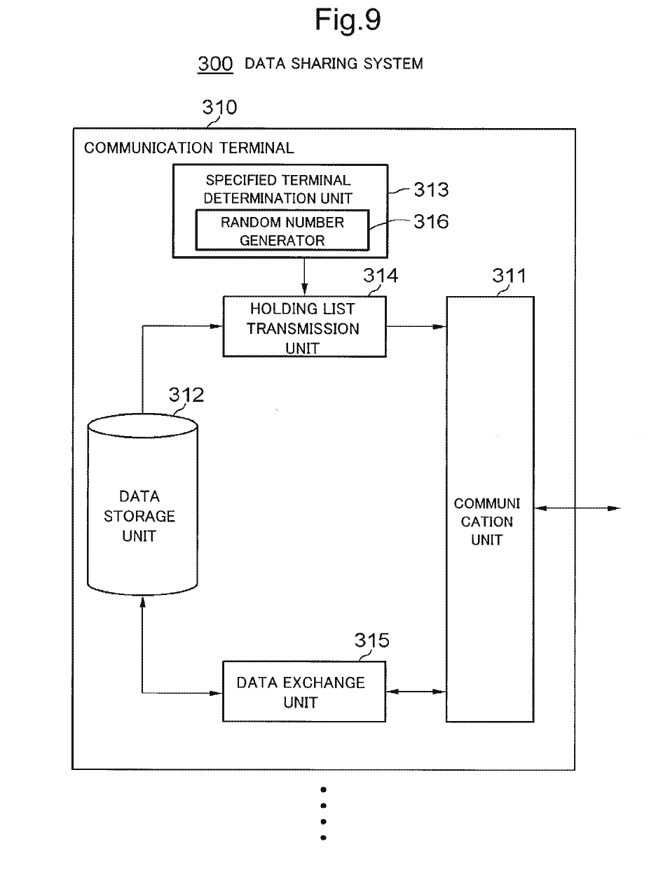

Referring to FIG. 9, a communication terminal 310 included in a data sharing system 300 according to a third exemplary embodiment of the present invention includes a communication unit 311, a data storage unit 312, a specified terminal determination unit 313, a holding list transmission unit 314, and a data exchange unit 315.

The communication unit 311, the data storage unit 312, the holding list transmission unit 314, and the data exchange unit 315 have the same functions as the communication unit 111, the data storage unit 112, the holding list transmission unit 114, and the data exchange unit 115, respectively, of the communication terminal 110 according to the first exemplary embodiment illustrated in FIG. 2.

The specified terminal determination unit 313 includes a random number generator 316, and has a function of determining whether or not the own communication terminal 310 is a specified terminal in accordance with a random number (pseudorandom number) generated by the random number generator 316. Specifically, in case of a random number generated by the random number generator 316 is included in a pre-determined range, the specified terminal determination unit 313 determines the own communication terminal 310 to be a specified terminal, otherwise to be an unspecified terminal. For example, the random number generator 316 generates random numbers that are uniformly distributed over an integer range of 0 to 9. The specified terminal determination unit 313 can classify 10 percent of a plurality of communication terminals as specified terminals and the remainder as unspecified terminals by means that the own communication terminal is determined to be a specified terminal if the generated random number is less than 1, otherwise to be an unspecified terminal. The aforementioned range may be either fixed or variable.

The configuration and operation of the communication terminal 310 other than the specified terminal determination unit 313 according to the present exemplary embodiment are the same as the communication terminal 110 according to the first exemplary embodiment.

Thus, according to the present exemplary embodiment, increase in bandwidth load on a wireless link caused by frequent transmission of holding lists can be suppressed. A reason for this is that, of all the communication terminals 310, only the communication terminals determined as specified terminals based on random numbers transmit holding lists to child communication terminals.

Further, according to the present exemplary embodiment, a communication terminal (unspecified terminal) receiving a holding list from another communication terminal (specified terminal) transmits and receives communication messages to and from the communication terminal (specified terminal) that is a source of the holding list that does not match the holding list of the own communication terminal, so that the communication terminals share data with each other. Therefore, data sharing between all the communication terminals present in a range of communication possible from the communication terminal (specified terminal) that transmits a holding list is possible.

In addition, by making the range to be compared with a generated random number variable, it is possible to easily change the percentage of a plurality of communication terminals to be determined as specified terminals.

### Fourth Exemplary Embodiment

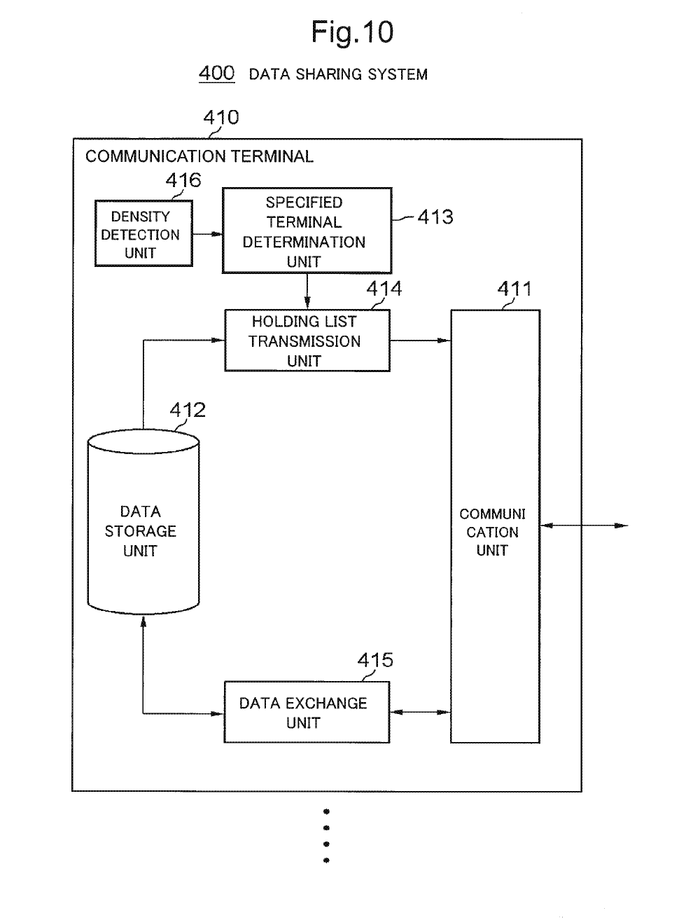

Referring to FIG. 10, a communication terminal 410 included in a data sharing system 400 according to a fourth exemplary embodiment of the present invention includes a communication unit 411, a data storage unit 412, a specified terminal determination unit 413, a holding list transmission unit 414, a data exchange unit 415, and a density detection unit 416.

The communication unit 411, the data storage unit 412, the holding list transmission unit 414, and the data exchange unit 415 have the same functions as the communication unit 111, the data storage unit 112, the holding list transmission unit 114, and the data exchange unit 115, respectively, of the communication terminal 110 according to the first exemplary embodiment illustrated in FIG. 2.

The density detection unit 416 has a function of detecting a density level of other communication terminals in the communication-available area of the own communication terminal 410. Choice of method for detecting a density level is arbitrary. For example, in case of each communication terminal 410 is connected to a network and transmits and receives communication messages to and from other communication terminals 410 via the network so that data sharing is carried out, the number of communication terminals connected to the network may be detected as a density level. For example, in a network conforming to a Wi-Fi direct specification, there exists a phase of detecting communication terminals to be connected prior to negotiation for selecting a group owner. Therefore, the number of communication terminals detected in this phase can be utilized as a density level. Further, in case of each communication terminal 410 transmits a certain communication message to other communication terminals in a constant cycle, a ratio of a no-signal period during which no communication message is received per unit time has correlation with a density level. Therefore, the aforementioned no-signal period ratio can be utilized as a density level.

The specified terminal determination unit 413 has a function of determining whether or not the own communication terminal 410 is a specified terminal based on the density level detected by the density detection unit 416. Specifically, the specified terminal determination unit 413 determines the own communication terminal as a specified terminal unconditionally in case of the density level is less than or equal to a threshold value. Further, in case of the density level is not less than nor equal to the threshold value, the specified terminal determination unit 413 determines whether or not the own communication terminal is a specified terminal by using a method similar to the method used by the specified terminal determination unit 213 according to the second exemplary embodiment or the method used by the specified terminal determination unit 313 according to the third exemplary embodiment.

The configuration and operation of the communication terminal 410 other than the specified terminal determination unit 413 and the density detection unit 416 according to the present exemplary embodiment are the same as the communication terminal 110 according to the first exemplary embodiment.

Thus, according to the present exemplary embodiment, increase in bandwidth load on a wireless link caused by frequent transmission of holding lists can be suppressed. A reason for this is that in a situation where communication terminals are so densely populated that the density level exceeds the threshold value, only the communication terminals that are determined as specified terminals transmit holding lists to other communication terminals.

Further, according to the present exemplary embodiment, a communication terminal (unspecified terminal) receiving a holding list from another communication terminal (specified terminal) transmits and receives communication messages to and from the communication terminal (specified terminal) that is a source of the holding list that does not match the holding list of the own communication terminal, so that the communication terminals share data with each other. Therefore, data sharing between all the communication terminals present in a range of communication possible from the communication terminal (specified terminal) that transmits a holding list is possible.

Furthermore, according to the present exemplary embodiment, in a situation where communication terminals are not so populated that the density level does not exceed the threshold value, communication terminals that can transmit holding lists are not limited to a subset of the communication terminals, therefore data sharing between an arbitrary pair of communication terminals based on exchange of communication messages is possible.

### Fifth Exemplary Embodiment

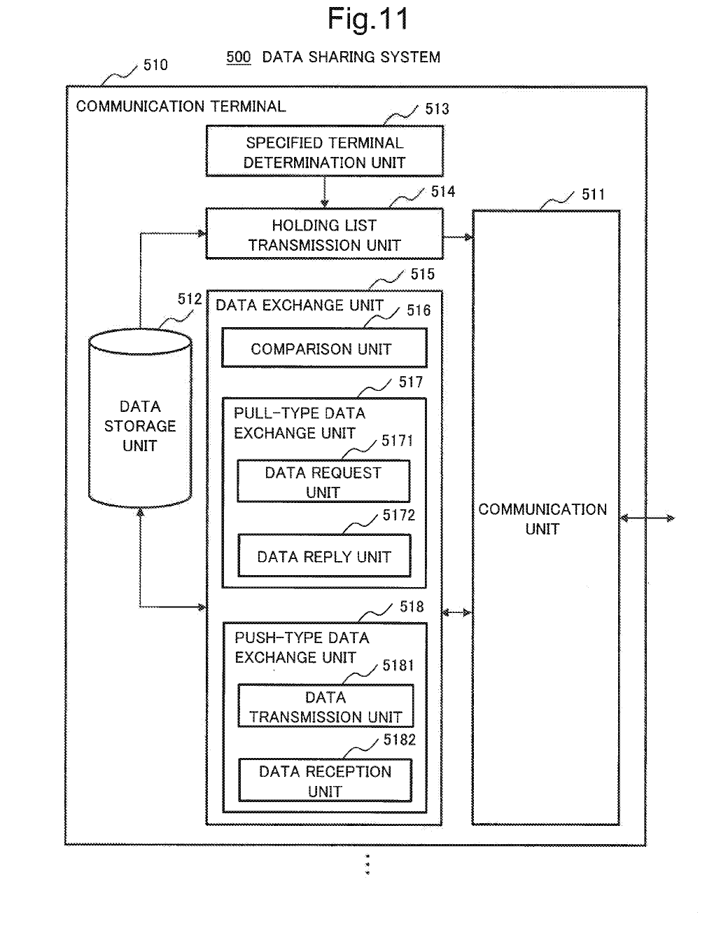

Referring to FIG. 11, a communication terminal 510 included in a data sharing system 500 according to a fifth exemplary embodiment of the present invention includes a communication unit 511, a data storage unit 512, a specified terminal determination unit 513, a holding list transmission unit 514, and a data exchange unit 515.

The communication unit 511, the data storage unit 512, the specified terminal determination unit 513, and the holding list transmission unit 514 have the same functions as the communication unit 111, the data storage unit 112, the specified terminal determination unit 113, and the holding list transmission unit 114, respectively, of the communication terminal 110 according to the first exemplary embodiment illustrated in FIG. 2. Alternatively, the communication unit 511, the data storage unit 512, the specified terminal determination unit 513, and the holding list transmission unit 514 have the same functions as the communication unit 211, the data storage unit 212, the specified terminal determination unit 213, and the holding list transmission unit 214, respectively, of the communication terminal 210 according to the second exemplary embodiment illustrated in FIG. 7. Alternatively, the communication unit 511, the data storage unit 512, the specified terminal determination unit 513, and the holding list transmission unit 514 have the same functions as the communication unit 311, the data storage unit 312, the specified terminal determination unit 313, and the holding list transmission unit 314, respectively, of the communication terminal 310 according to the third exemplary embodiment illustrated in FIG. 9. Alternatively, the communication unit 511, the data storage unit 512, the specified terminal determination unit 513, and the holding list transmission unit 514 have the same functions as the communication unit 411, the data storage unit 412, the specified terminal determination unit 413, and the holding list transmission unit 414, respectively, of the communication terminal 410 according to the fourth exemplary embodiment illustrated in FIG. 10.

The data exchange unit 515 has a function of transmitting and receiving communication messages through the communication unit 511 to and from another communication terminal 510 so as to share data with each other. The data exchange unit 515 includes a comparison unit 516, a pull-type data exchange unit 517, and a push-type data exchange unit 518.

The comparison unit 516 has a function of comparing a holding list received from another communication terminal 510 with a holding list of the own communication terminal and determining data to be acquired from the other communication terminal 510 and data to be provided for the other communication terminal 510.

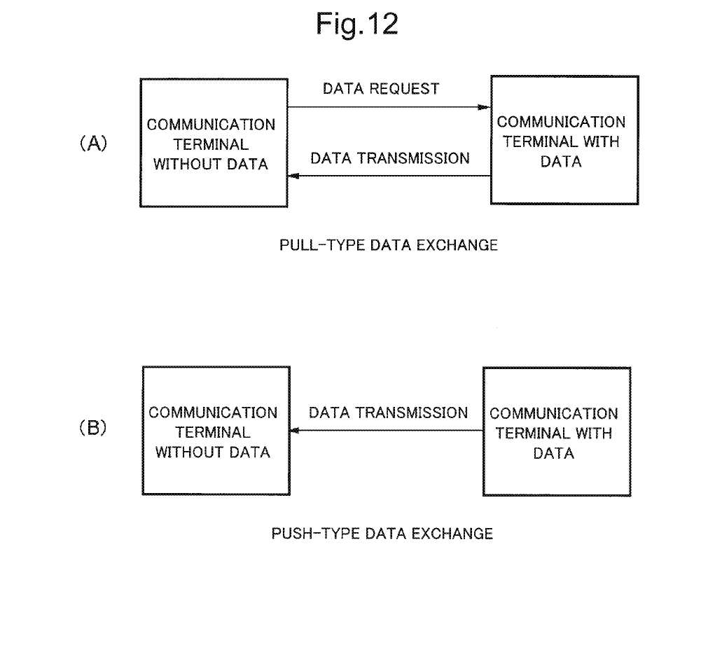

The pull-type data exchange unit 517, as illustrated in FIG. 12(A), has a function of data sharing between communication terminals by a method in which a communication terminal that does not hold data transmits a data request to a communication terminal that holds the data and the communication terminal that receives the data request transmits the data to the communication terminal that is the request source. The pull-type data exchange unit 517 includes a data request unit 5171 and a data reply unit 5172. The data request unit 5171 has a function of making a request for the data to be acquired determined by the comparison unit 516 to another communication terminal 510 through the communication unit 511, receiving, through the communication unit 511, the data transmitted through use of a communication message from the other communication terminal 510 in response to the request, and storing the data into the data storage unit 512. On the other hand, the data reply unit 5172 has a function of reading out data requested by the pull-type data exchange unit 517 of another communication terminal 510 by use of a communication message from the data storage unit 512 and transmitting the data to the other communication terminal 510 through the communication unit 511.

The push-type data exchange unit 518, as illustrated in FIG. 12(B), has a function of data exchange between communication terminals by a method in which a communication terminal holding data transmits the data to a communication terminal not holding the data, without a data request from the communication terminal. The push-type data exchange unit 518 includes a data transmission unit 5181 and a data reception unit 5182. The data transmission unit 5181 has a function of reading out the data to be provided determined by the comparison unit 516 from the data storage unit 512 and transmitting the data to another communication terminal 510 through the communication unit 511. On the other hand, the data reception unit 5182 has a function of storing, into the data storage unit 512, the data received through use of a communication message from the push-type data exchange unit 518 of another communication terminal 510.

Next, operations of the data sharing system 500 according to the present exemplary embodiment will be described. Of the operations of the data sharing system 500 according to the present exemplary embodiment, the operations other than the operation of the data exchange unit 515 are the same as the operations in the first to fourth exemplary embodiments. Hereinafter, the operation of the data exchange unit 515 will be described in detail.

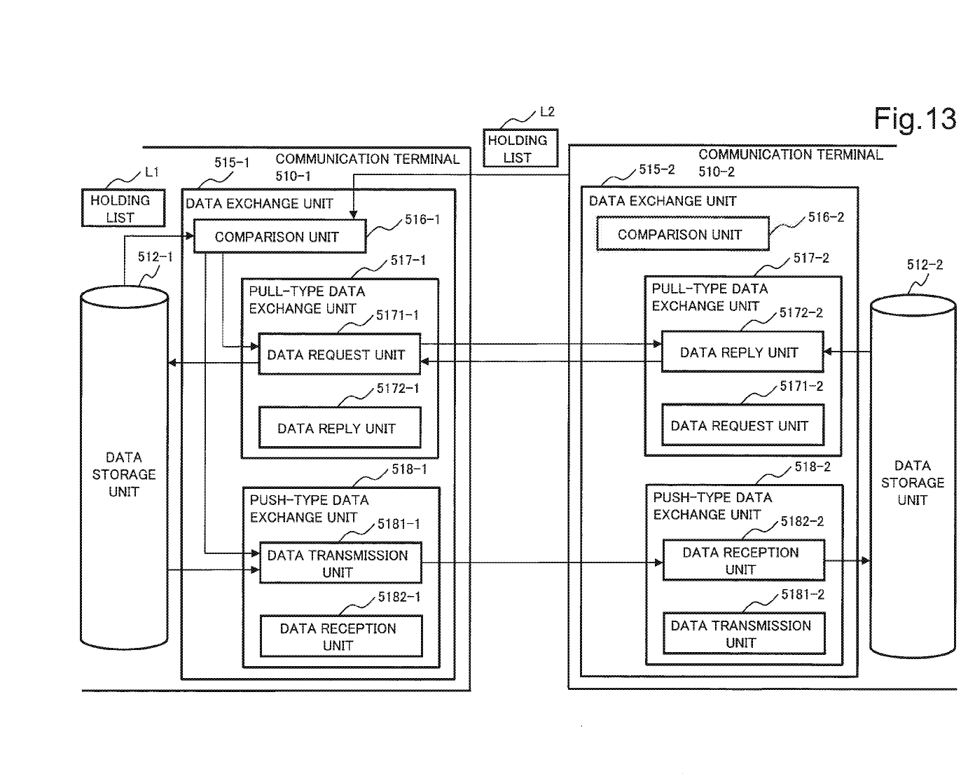

FIG. 13 is an explanatory diagram of a data exchange procedure performed between two communication terminals 510. In FIG. 13, a communication terminal 510-1 is a communication terminal that receives a holding list, and a communication terminal 510-2 is a communication terminal that is a source of the holding list.

A comparison unit 516-1 in a data exchange unit 515-1 on the communication terminal 510-1 side, when receiving a holding list L2 from the communication terminal 510-2, compares the holding list L2 with a holding list L1 in data stored in a data storage unit 512-1 of the own communication terminal. Then, in case of there are data listed in the holding list L2 that are not listed in the holding list L1, the comparison unit 516-1 determines the data to be data that need to be acquired from the communication terminal 510-2, and notifies the determination to a data request unit 5171-1 in a pull-type data exchange unit 517-1. Further, in case of there are data listed in the holding list L1 that are not listed in the holding list L2, the comparison unit 516-1 determines the data to be data that need to be provided for the communication terminal 510-2, and notifies the determination to a data transmission unit 5181-1 in a push-type data exchange unit 518-1.

The data request unit 5171-1 in the pull-type data exchange unit 517-1 on the communication terminal 510-1 side starts operation when a notification is received from the comparison unit 516. The data request unit 5171-1 first transmits a communication message that requests the data to be acquired from the communication terminal 510-2 to a pull-type data exchange unit 517-2 on the communication terminal 510-2 side. A data reply unit 5172-2 in the pull-type data exchange unit 517-2 analyzes the received communication message, reads out the requested data from a data storage unit 512-2, and transmits the data through use of a communication message to the pull-type data exchange unit 517-1 on the communication terminal 510-1 side which is a source of the request. The data request unit 5171-1 in the pull-type data exchange unit 517-1 takes out the data from the received communication message, and stores the data into the data storage unit 512-1.

Further, the data transmission unit 5181-1 in the push-type data exchange unit 518-1 on the communication terminal 510-1 side starts operation when a notification is received from the comparison unit 516. The data transmission unit 5181-1 reads out the data to be provided for the communication terminal 510-2 from the data storage unit 512-1, and transmits the data through use of a communication message to a push-type data exchange unit 518-2 on the communication terminal 510-2 side. A data reception unit 5182-2 in the push-type data exchange unit 518-2 on the communication terminal 510-2 side takes out the data from the received communication message, and stores the data into the data storage unit 512-2.

Thus, according to the present exemplary embodiment, an effect similar to the first to fourth exemplary embodiments is obtained, and data exchange can be efficiently carried out. A reason for this is that the data transmitted and received between communication terminals are limited to data to be shared between the communication terminals and there is no unnecessary operation that data not to be shared between communication terminals are transmitted and received between the communication terminals.

### Sixth Exemplary Embodiment

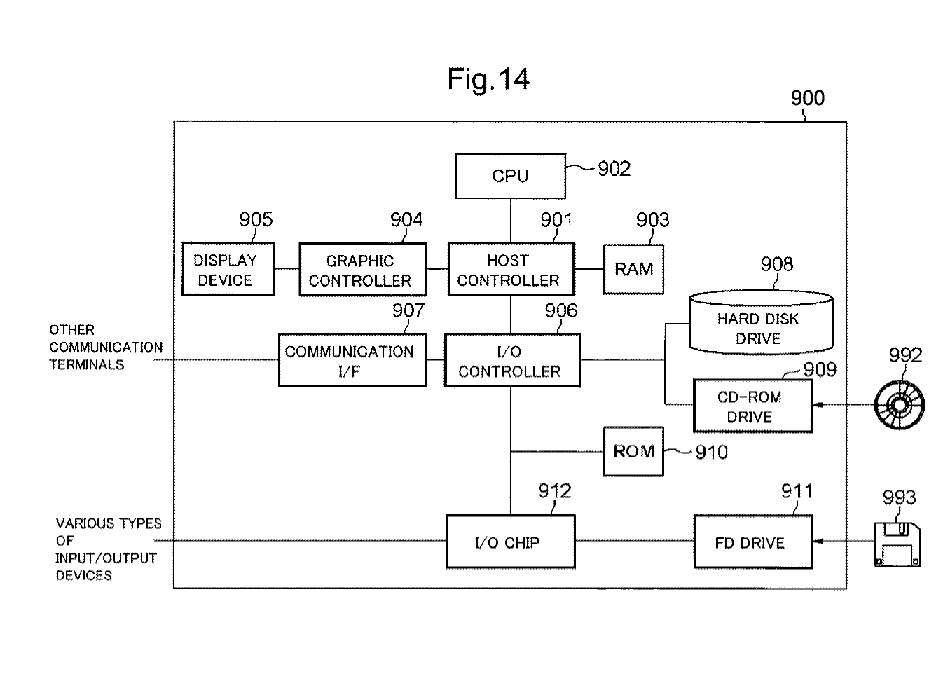

FIG. 14 illustrates an example of a hardware configuration in a case that a communication terminal in each of the foregoing exemplary embodiments is configured by an electronic information processing apparatus such as a computer. A communication terminal 910 in this example includes a CPU (Central Processing Unit) peripheral unit, an input/output unit, and a legacy input/output unit. The CPU peripheral unit includes a CPU 902, a RAM (Random Access Memory) 903, a graphic controller 904, and a display device 905 that are interconnected by a host controller 901. The input/output unit includes a communication interface 907, a hard disk drive 908, and a CD-ROM (Compact Disk Read Only Memory) drive 909 that are connected to the host controller 901 through an input/output controller 906. The legacy input/output unit includes a ROM (Read Only Memory) 910, a flexible disk drive 911, and an input/output chip 912 that are connected to the input/output controller 906.

The host controller 901 connects the RAM 903, the CPU 902 that accesses the RAM 903 at a high transfer rate, and the graphic controller 904. The CPU 902 operates to control each unit based on a program stored in the ROM 910 and the RAM 903. The graphic controller 904 acquires image data generated on a frame buffer provided within the RAM 903 by the CPU 902 and the like, and displays the image data on the display device 905. Alternatively, the graphic controller 904 may contain therein a frame buffer that stores image data generated by the CPU 902 and the like.

The input/output controller 906 connects the host controller 901 with the hard disk drive 908, which is a relatively high-speed input/output device, the communication interface 907, and the CD-ROM drive 909. The hard disk drive 908 stores a program and data that the CPU 902 uses. The communication interface 907 connects to another communication terminal 320 to transmit and receive a program or data. The CD-ROM drive 909 reads a program or data from a CD-ROM 992, and provides the program or data for the hard disk drive 908 and the communication interface 907 via the RAM 903.

The ROM 910 and relatively low-speed input/output devices including the flexible disk drive 911 and the input/output chip 912, are connected to the input/output controller 906. The ROM 910 stores a boot program that the communication terminal 310 executes at the time of start-up, a programs that depends on hardware of the communication terminal 310, or the like. The flexible disk drive 911 reads a program or data from a flexible disk 993, and provides the program or data for the hard disk drive 908 and the communication interface 907 via the RAM 903. The input/output chip 912 connects the flexible disk drive 911, or various types of input/output devices via a parallel port, a serial port, a keyboard port, a mouse port, or the like.

The program that the CPU 902 executes is stored on a recording medium, such as the flexible disk 993, the CD-ROM 992, and an IC (Integrated Circuit) card, and provided by a user. The program stored on the recording medium may be compressed or non-compressed. The program is installed on the hard disk drive 908 from the recording medium, read out onto the RAM 903, and executed by the CPU 902. The program executed by the CPU 902 causes the communication terminal 910 to function as the communication unit, the data storage unit, the specified terminal determination unit, the holding list transmission unit, the data exchange unit, and the like in each of the aforementioned exemplary embodiments.

The program described above may be stored on an external storage medium. As for the storage medium, it is possible to use an optical recording medium, such as a DVD (Digital Versatile Disk) and a PD (Phase Disk), a magneto-optical recording medium, such as an MD (MiniDisk), a tape medium, a semiconductor memory such as an IC card, and the like besides the flexible disk 993 and the CD-ROM 992. Further, an information sharing system may be provided as a program acquired via a network, by using a storage medium, such as a hard disk and a RAM, provided in a server system connected to a dedicated communication network or the Internet, as a recording medium.

### Other Exemplary Embodiments

While the present invention has been described with reference to several exemplary embodiments, the present invention is not limited to the foregoing exemplary embodiments only, but various types of other additions and changes can be made. For example, exemplary embodiments as mentioned below are also included in the present invention.

As a method to determine whether or not a communication terminal itself is a specified terminal, a method utilizing a communication network topology, a method carrying out the determination through negotiation between communication terminals, and a method carrying out the determination by utilizing random numbers have been exemplified. However, other methods may also be utilized as a method to determine whether or not a communication terminal itself is a specified terminal. For example, a method in which a communication terminal is determined as a specified terminal if hardware performance (CPU performance, memory capacity, communication bandwidth, or the like) of the own communication terminal is higher than or equal to a threshold value, or the like may be used.

Further, as a method to determine whether or not a communication terminal itself is a specified terminal by utilizing a communication network topology, a method employed in a network that conforms to a Wi-Fi direct specification has been exemplified. However, as a communication network topology, a network topology that is clustered into at least two or more hierarchies or a network topology to which a Connected Dominated Set is applied may be utilized.

This application is based upon and claims the benefit of priority from Japanese patent application No. 2013-032834, filed on Feb. 22, 2013, the disclosure of which is incorporated herein in its entirety by reference.

### INDUSTRIAL APPLICABILITY

The present invention is applicable to a data sharing system that performs sharing of data, such as various types of content, between on-board communication terminals on vehicles such as automobiles, or between portable communication terminals.

### REFERENCE SIGNS LIST

100 Data sharing system
110 Communication terminal
111 Communication unit
112 Data storage unit
113 Specified terminal storage unit
114 Holding list transmission unit
115 Data exchange unit

1. A data sharing system in which data are shared between a plurality of communication terminals capable of wirelessly transmitting and receiving a communication message to and from each other, wherein
each of the communication terminals comprises:
a communication unit that transmits and receives the communication message to and from another of the communication terminals;
a data storage unit that stores one or more pieces of data;
a specified terminal determination unit that determines whether or not the own communication terminal is a specified terminal;
a holding list transmission unit that transmits, in case of the own communication terminal is the specified terminal, a holding list that lists information about the data stored in the data storage unit to another of the communication terminals through use of the communication message; and
a data exchange unit that receives the holding list from another of the communication terminals, and transmits and receives the communication message to and from the other communication terminals that is a source of the holding list that does not match the holding list of the own communication terminal so as to share data with each other.

2. The data sharing system according to claim 1, wherein
the specified terminal determination unit determines whether or not the own communication terminal is the specified terminal in accordance with whether or not the own communication terminal functions as a relay terminal in case of a network to which the own communication terminal is connected is a network that has a network topology in which communication terminals that function as the relay terminals are limited to a subset of all communication terminals.

3. The data sharing system according to claim 1, wherein
each of the communication terminals is connected to a network that conforms to a Wi-Fi Direct specification.

4. The data sharing system according to claim 1, wherein
the specified terminal determination unit determines whether or not the own communication terminal is the specified terminal by performing negotiation with another of the communication terminals.

5. The data sharing system according to claim 1, wherein
the communication unit conforms to a Wi-Fi Direct specification.

6. The data sharing system according to claim 1, wherein
each of the communication terminals comprises
a density detection unit that detects a density level of another of the communication terminals in a communication-available area of the own communication terminal, and
the specified terminal determination unit, in the determination, unconditionally determines the own communication terminal as the specified terminal in case of the detected density level is less than or equal to a threshold value.

7. The data sharing system according to claim 1, wherein
the data exchange unit comprises:
a comparison unit that compares the holding list received from another of the communication terminals with the holding list of the own communication terminal and determines data to be acquired from another of the communication terminals and data to be provided another of the communication terminals;
a first data exchange unit including a data request unit that makes a request for the data determined to be acquired to another of the communication terminals through use of the communication message, receives data transmitted through use of the communication message from another of the communication terminals in response to the request, and stores the data into the data storage unit, and a data reply unit that reads out, from the data storage unit, data requested by another of the communication terminals through use of the communication message and transmits the data to another of the communication terminals; and
a second data exchange unit including a data transmission unit that reads out, from the data storage unit, the data determined to be provided and transmits the data to another of the communication terminals through use of the communication message, and a data reception unit that stores data received from another of the communication terminals through use of the communication message into the data storage unit.

8. A data sharing method in which data are shared between a plurality of communication terminals capable of wirelessly transmitting and receiving a communication message to and from each other, wherein:
each of the communication terminals determines whether or not the own communication terminal is a specified terminal;
the communication terminal determined that the own communication terminal is the specified terminal transmits a holding list that lists information about data held by the own communication terminal to another of the communication terminals through use of the communication message; and
the communication terminal receiving the holding list from another of the communication terminals transmits and receives the communication message to and from the other communication terminals that is a source of the holding list that does not match the holding list of the own communication terminal so as to share data with each other.

9. A communication terminal comprising:
a communication unit that transmits and receives a communication message to and from another communication terminal;
a data storage unit that stores one or more pieces of data;
a specified terminal determination unit that determines whether or not the own communication terminal is a specified terminal;
a holding list transmission unit that transmits, in case of the own communication terminal is the specified terminal, a holding list that lists information about the data stored in the data storage unit to another of the communication terminals through use of the communication message; and
a data exchange unit that receives the holding list from another of the communication terminals, and transmits and receives the communication message to and from the other communication terminals that is a source of the holding list that does not match the holding list of the own communication terminal so as to share data with each other.

10. The communication terminal according to claim 9, wherein
the specified terminal determination unit determines whether or not the own communication terminal is the specified terminal in accordance with whether or not the own communication terminal functions as a relay terminal in case of a network to which the own communication terminal is connected is a network that has a network topology in which communication terminals that function as the relay terminals are limited to a subset of all communication terminals.

11. The communication terminal according to claim 9, wherein
the communication unit is connected to a network that conforms to a Wi-Fi Direct specification.

12. The communication terminal according to claim 9, wherein
the specified terminal determination unit determines whether or not the own communication terminal is the specified terminal by performing negotiation with another of the communication terminals.

13. The communication terminal according to claim 9, wherein
the communication unit conforms to a Wi-Fi Direct specification.

14. The communication terminal according to claim 9, wherein
each of the communication terminals comprises
a density detection unit that detects a density level of another of the communication terminals in a communication-available area of the own communication terminal, and
the specified terminal determination unit, in the determination, unconditionally determines the own communication terminal as the specified terminal in case of the detected density level is less than or equal to a threshold value.

15. The communication terminal according to claim 9, wherein
the data exchange unit comprises:
a comparison unit that compares the holding list received from another of the communication terminals with the holding list of the own communication terminal and determines data to be acquired from another of the communication terminals and data to be provided for another of the communication terminals;
a first data exchange unit including a data request unit that makes a request for the data determined to be acquired to another of the communication terminals through use of the communication message, receives data transmitted through use of the communication message from another of the communication terminal in response to the request, and stores the data into the data storage unit, and a data request reply unit that reads out, from the data storage unit, data requested by another of the communication terminals and transmits the data to another of the communication terminals through use of the communication message; and
a second data exchange unit including a data transmission unit that reads out, from the data storage unit, the data determined to be provided and transmits the data to another of the communication terminals through use of the communication message, and a data reception unit that stores data received from another of the communication terminals through use of the communication message into the data storage unit.

16. (canceled)

17. (canceled)

18. The communication terminal according to claim 10, wherein
the communication unit is connected to a network that conforms to a Wi-Fi Direct specification.

19. The communication terminal according to claim 10, wherein
the specified terminal determination unit determines whether or not the own communication terminal is the specified terminal by performing negotiation with another of the communication terminals.

20. The communication terminal according to claim 10, wherein
the communication unit conforms to a Wi-Fi Direct specification.

21. The communication terminal according to claim 10, wherein
each of the communication terminals comprises
a density detection unit that detects a density level of another of the communication terminals in a communication-available area of the own communication terminal, and
the specified terminal determination unit, in the determination, unconditionally determines the own communication terminal as the specified terminal in case of the detected density level is less than or equal to a threshold value.

22. The communication terminal according to claim 10, wherein
the data exchange unit comprises:
a comparison unit that compares the holding list received from another of the communication terminals with the holding list of the own communication terminal and determines data to be acquired from another of the communication terminals and data to be provided for another of the communication terminals;
a first data exchange unit including a data request unit that makes a request for the data determined to be acquired to another of the communication terminals through use of the communication message, receives data transmitted through use of the communication message from another of the communication terminal in response to the request, and stores the data into the data storage unit, and a data reply unit that reads out, from the data storage unit, data requested by another of the communication terminals and transmits the data to another of the communication terminals through use of the communication message; and
a second data exchange unit including a data transmission unit that reads out, from the data storage unit, the data determined to be provided and transmits the data to another of the communication terminals through use of the communication message, and a data reception unit that stores data received from another of the communication terminals through use of the communication message into the data storage unit.
